(19) United States
(12) Patent Application Publication
(10) Pub. No.: US 2026/0072216 A1
(43) Pub. Date: Mar. 12, 2026

(54) Multi-mode optical waveguides with deviations in geometric features to improve performance

(71) Applicant: Ciena Corporation, Hanover, MD (US)

(72) Inventor: Yves Painchaud, Québec (CA)

(73) Assignee: Ciena Corporation, Hanover, MD (US)

(21) Appl. No.: 18/883,035

(22) Filed: Sep. 12, 2024

(51) Int. Cl. G02B 6/293; G02B 27/00

(52) U.S. Cl. CPC G02B 6/29344; G02B 6/2938; G02B 27/0012

(57) ABSTRACT

Systems and methods are provided for designing and fabricating a multi-mode waveguide, such as a waveguide incorporated in a Multi-Mode Interferometer (MMI) device having at least one multi-mode waveguide. According to one implementation, a multi-mode waveguide includes one or more side boundary sections that are non-parallel to a propagation axis of the multi-mode waveguide. In another implementation, a multi-mode waveguide having a propagation axis extending therethrough includes a top planar boundary parallel to the propagation axis and a bottom planar boundary parallel to the propagation axis. Furthermore, the multi-mode waveguide includes a first side boundary having at least one section that is non-parallel to the propagation axis with deviations in geometric features associated therewith. Such deviations are selected based on one or more performance metrics, for improvement thereof.

### FIELD OF THE DISCLOSURE

The present disclosure relates generally to optical network equipment. More particularly, the present disclosure relates to multi-mode optical waveguides and Multi-Mode Interferometer (MMI) devices and further relates to modifying the boundaries of waveguides to improve constructive interference patterns, as well as other deviations in geometric features to improve performance.

### BACKGROUND

Photonic interferometers or photonic interference devices may be used in optical systems for measuring small displacements, refractive index changes, and other quantities. An interferometer typically includes an optical “beam splitter” that splits an optical beam into multiple beams, each propagating along dissimilar paths having various lengths, thereby resulting in different phase shift characteristics. Also, an interferometer includes an optical “beam combiner” for re-combining the multiple beams back into one or more output beams. In particular, Multi-Mode Interference (MMI) devices may provide beam splitters and beam combiners that include multiple “modes” (i.e., optical paths along which light travels), and are particularly useful in short range applications, such as optical integrated circuit devices. While most waveguides in optical systems are used for single mode propagation, the waveguide of an MMI device operates using a large number of modes encountering complex interference patterns while propagating through the waveguide. Typically, an MMI device is fabricated as a simple rectangular box (i.e., rectangular prism), usually formed as a wide strip in a relatively flat plane on a circuit board.

### BRIEF SUMMARY

The present disclosure relates to systems and methods for designing, simulating, and fabricating multi-mode waveguides and Multi-Mode Interferometer (MMI) devices used in an optical network. According to one implementation of a multi-mode waveguide having a propagation axis extending therethrough, the multi-mode waveguide includes a top planar boundary parallel to the propagation axis and a bottom planar boundary parallel to the propagation axis. In addition, the multi-mode waveguide includes a first side boundary having at least one section that is non-parallel to the propagation axis.

In some embodiments, the multi-mode waveguide may further include a second side boundary opposite of the first side boundary. The second side boundary, for instance, also has at least one section that is non-parallel to the propagation axis. The first and second side boundaries may each include multiple sections that are non-parallel to the propagation axis. An arrangement of the multiple sections of the first and second side boundaries is configured to result in the top planar boundary and bottom planar boundary essentially forming a butterfly-like shape. In some embodiments, the multi-mode waveguide may include a rectangular cross-section that varies along its length.

The multi-mode waveguide may be considered to be a first multi-mode waveguide that is connected directly to a second multi-mode waveguide to thereby form a device that operates as an optical hybrid. The first multi-mode waveguide may further include multiple input ports at an input face plate thereof. A first set of output ports may be arranged at an output face plate of the first multi-mode waveguide. Also, a second set of output ports may be arranged at an output face plate of the second multi-mode waveguide. In some embodiments, each of the multiple input ports may be larger than each of the first and second sets of output ports. Also, the multiple input ports may be offset from a natural spacing arrangement along the input face plate of the first multi-mode waveguide. Furthermore, the first and second sets of output ports may be offset from a natural spacing arrangement along the output face plates of the first and second multi-mode waveguides.

In some embodiments, the first multi-mode waveguide may be a 2×4 waveguide having two inputs and four outputs and the second multi-mode waveguide may be a 2×2 waveguide having two inputs and two outputs. For example, two of the four output of the 2×4 waveguide may be configured to propagate optical signals directly to the two inputs of the 2×2 waveguide. The second multi-mode waveguide may include a second top planar boundary and a second bottom planar boundary parallel to a second propagation axis of the second multi-mode waveguide and may further include one or more side boundaries each having at least one section that is non-parallel to the second propagation axis. For example, the second propagation axis of the second multi-mode waveguide may be angled with respect to the propagation axis of the first multi-mode waveguide.

According to some embodiments, geometric features of the first side boundary may be configured to improve transmission characteristics with respect to one or more of a) splitting optical signals substantially evenly to a plurality of output ports, b) providing desired phase offsets of the optical signals at the plurality of output ports, and c) providing relatively low loss. The multi-mode waveguide may further include one or more single-mode input ports and one or more single-mode output ports. In some embodiments, the multi-mode waveguide may have a non-rectangular, non-parallelogram, and non-trapezoidal profile. The multi-mode waveguide, for instance, may have a flat form-factor and may be fabricated on an optical integrated circuit board. The top planar boundary of the multi-mode waveguide may be parallel with the bottom planar boundary.

In some cases, the multi-mode waveguide may be designed, simulated, and/or fabricated according to predetermined processes. For example, geometric features of the first side boundary may be determined using a process including a step of determining values for the geometric features. The process may also include creating a waveguide simulation with the values and changing the values based on results of the waveguide simulation. Furthermore, the process may include repeating the creating and changing steps until the waveguide simulation meets a set of performance metrics.

### BRIEF DESCRIPTION OF THE DRAWINGS

The present disclosure is detailed through various drawings, where like components or steps are indicated by identical reference numbers for clarity and consistency.

FIG. 1 is a diagram illustrating a Multi-Mode Interferometer (MMI) optical component having two multi-mode waveguides, according to various embodiments.

FIG. 2 is a diagram illustrating a 1×1 MMI optical component, according to various embodiments.

FIG. 3 is a diagram illustrating an interference propagation pattern through the multi-mode waveguide shown in FIG. 2, according to various embodiments.

FIG. 4 is a diagram illustrating a 1×4 MMI optical component, according to various embodiments.

FIGS. 5 and 6 are diagrams illustrating interference propagation patterns through the multi-mode waveguide shown in FIG. 4, according to various embodiments.

FIG. 7 is a diagram illustrating a 2×4 MMI optical component, according to various embodiments.

FIG. 8 is a diagram illustrating the MMI optical component of FIG. 1 in a compressed manner, according to various embodiments.

FIG. 9 is a diagram illustrating a 2×4 MMI optical component having two multi-mode waveguides in which the side walls of the multi-mode waveguides are non-parallel with propagation axes of the respective multi-mode waveguides, according to various embodiments.

FIG. 10 is a flow diagram illustrating a process for determining geometric features of the 2×4 MMI optical waveguide of FIG. 9, according to various embodiments.

FIGS. 11A and 11B are graphs comparing transmission characteristics of the 2×4 MMI optical component of FIG. 9 with other MMI components, according to various embodiments.

### DETAILED DESCRIPTION

A photonic integrated circuit is a device that integrates multiple photonic functions for information signals on optical wavelengths typically in the visible spectrum or near infrared 850 nm-1650 nm. Such photonic integrated circuits may include waveguides, beam splitters, beam combiners, phase shifters, photodetectors, amplifiers, and attenuators. Combinations of such optical elements may yield more complex optical elements, including modulators and interferometers (i.e., interference devices). Among various optical elements used in photonic integrated circuits, interferometers are widely used for measurements of small displacements, refractive index changes and other quantities in science and industry. It is also used to transmit and receive information through modulation and detection of an optical signal. An interferometer includes an optical beam splitter, a section of dissimilar path lengths, and an optical beam combiner. In an interferometer, an incoming light is split into multiple paths by the optical beam splitter (i.e., two or more paths), acquires different phase shifts through the different path lengths, and is re-combined by the optical beam combiner.

### Multi-Mode Interferometer (MMI) Devices

In particular, multi-mode interference (MMI) devices may provide beam splitters and beam combiners, and therefore may be included as elements of an interferometer. While most waveguides in photonic integrated circuits may be designed for a single mode propagation, MMI devices operate using a large number of modes.

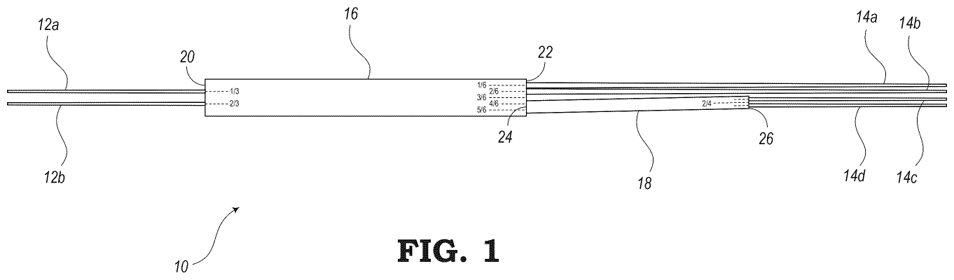

FIG. 1 is a diagram illustrating an embodiment of an MMI optical component 10. It may be noted that the relative dimensions of the MMI optical component 10, as shown in FIG. 1, may accurately depict the elongated nature of MMI devices. However, in order to show certain characteristics of these MMI devices throughout the present disclosure, other figures are shown in a compressed fashion (i.e., with the length shortened or the width widened) to convey certain features more easily.

The MMI optical component 10, in this embodiment, is a 2×4 MMI device having two input ports 12a, 12b and four output ports 14a, 14b, 14c, 14d. Also, the MMI optical component 10 includes a first multi-mode waveguide 16 and a second multi-mode waveguide 18. In some embodiments, the input ports 12a, 12b may be slightly tapered (e.g., narrower to wider) along their lengths (from left to right on the page). Likewise, the output ports 14a, 14b, 14c, 14d may also be tapered in a wider to narrower manner (from left to right on the page). Also, the input ports 12a, 12b and output ports 14a, 14b, 14c, 14d may each have a square cross-sectional shape.

In some embodiments, the input ports 12a, 12b may be arranged at symmetrical locations on an input face plate 20 of the first multi-mode waveguide 16. In particular, the input ports 12a, 12b may be arranged at a 1/3 point and a 2/3 point of the width of the input face plate 20. The first multi-mode waveguide 16 also includes an output face plate 22 at its back end. The output ports 14a and 14b extend directly from the output face plate 22 at 1/6 and 2/6 positions. The second multi-mode waveguide 18 has an input face plate 24 that extends from the output face plate 22 of the first multi-mode waveguide 16 at the 4/6 and 5/6 positions. Also, the second multi-mode waveguide 18 includes a propagation axis (i.e., general propagation direction of light beams through the device), wherein this propagation axis is angled slightly with respect to a propagation axis of the first multi-mode waveguide 16. This feature of angled propagation axes can be seen more easily with respect to FIG. 8 shown in the compressed form. Furthermore, the second multi-mode waveguide 18 includes an output face place 26, from which the output ports 14c and 14d extend at 1/4 and 3/4 positions.

In some embodiments, the MMI optical component 10 may be configured flat on a circuit board of an optical integrated circuit. As such, FIG. 1 would thereby represent a top view of the MMI optical component 10. In some embodiments, the first multi-mode waveguide 16 and the second multi-mode waveguide 18 may be a relatively flat. The first multi-mode waveguide 16 may have a shape like a rectangular prism. The second multi-mode waveguide 18 may have a shape like a parallelopiped.

Typically, a MMI device is fabricated as a simple wide rectangular stripe in a 2-dimensional flat plane and behaves as a multi-mode waveguide. In such a MMI device, an incoming optical information signal (used interchangeably herein with “light”) of a certain transverse optical profile (i.e., the intensity of the incoming light varies in a direction transverse to the propagation direction) simultaneously excites multiple modes at an input face of the MMI device with different amplitudes which then propagate at different phase velocities. In the paraxial regime (i.e., an angle between an incoming light and the propagation direction always remains smaller than few degrees), after a certain propagation distance, the modes excited at the input face are recombined in-phase such that they reproduce the optical transverse profile of the incoming light at the input face. This phenomenon is referred to as self-imaging. Furthermore, such self-imaging occurs at multiple locations (referred herein to as “self-imaging points”) during the propagation and allows a MMI device to split an incoming light into two or more reproductions of the incoming light at an output face of the MMI device. In particular, most MMI devices are designed to provide multiple reproductions of an incoming light at the output face with nearly equal intensities. In such a MMI device, output ports may be placed at self-imaging points, where the MMI device may act as a beam splitter. A MMI device, with two input ports for two incoming light beams, may act as a beam combiner.

Although single-mode waveguides are often used in integrated circuits, it is common to provide adiabatic tapers as the input waveguides that bring the optical signal up to the input face of the MMI. In such a taper, the waveguide is single-mode at its input and becomes gradually multi-mode as its width increases towards the input face of the MMI. Providing small width single-mode waveguides up to the MMI input would cause strong divergence of the light inside the MMI. Increasing the size of the optical profile at the input face of the MMI device, through the use of tapers, allows to mitigate such diffraction and to remain closer to the paraxial regime.

An optical hybrid interferometer may also be constructed by a combination of MMI devices, including a 2×4 MMI device (with two input ports and four outputs) and a 2×2 MMI device (with two input ports and two output ports). The 2×4 MMI device may be in the so-called paired-interference configuration. Two of the output ports of the 2×4 MMI device are connected to the two input ports of the 2×2 MMI device via two arms, respectively, which have different lengths as discussed previously. Such combination of MMI devices provides the functionality of a 90-degree optical hybrid as long as the phase shift of the bottom arm exceeds the phase shift of the upper arm by 45 degrees, as is known in the art.

For the interferometers with separate arms, as discussed above, their proper operation critically depends on the accuracy of a phase shift difference Δφ, between the two arms connecting the MMI devices, specifically only on Δφ, instead of a phase shift of φ in one arm or one of φ+Δφ p in the other arm. However, for robustness of fabricated interferometer devices, the arms are commonly designed as short as possible (and accordingly a common phase shift value q as small as possible). In an interferometer device with long arms, small deviations in any characteristics in the device may result in substantial errors in the phase shift difference Δφ. Therefore, the device may not function as designed in conventional designs of interferometers with separate arms.

In an example 2×2 MMI device, for example, an incoming light from each of two input ports at an input face of the 2×2 MMI device may excite multiple modes. The light in the multiple modes generally propagates along a propagation axis of the 2×2 MMI device with different phase velocities. The multiple modes (paths) of light interfere with other modes and exit from two output ports. When a light beam enters the 2×2 MMI device from one of the input ports, the 2×2 MMI device may act as an optical beam splitter. Based on predetermined interference patterns, the light may have two higher intensity points (or self-imaging point) where the two output ports may be configured, acting as an optical beam combiner. The modes interfere with the same phases as those they had at the input face and, apart from a mirror inversion, reproduce the same field transverse distribution. This phenomena, in which the recombined light constructively interferes, is called “self-imaging.”

### Embodiment of a 1×1 MMI Device

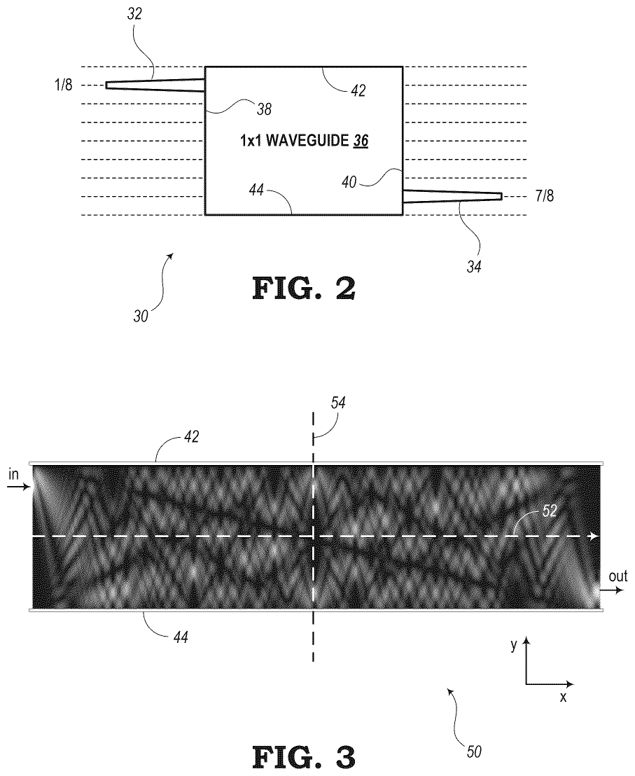

FIG. 2 is a diagram showing a top view of an embodiment of a 1×1 MMI device 30 shown in a compressed form. The 1×1 MMI device 30 includes an input port 32 (e.g., having a tapered configuration) at a random location, e.g., a 1/8 position, and an output port 34 (e.g., having a tapered configuration) at a 7/8 position. The 1×1 MMI device 30 may include a waveguide 36 with a rectangular profile (e.g., rectangular prism). An input face plate 38 is connected to the input port 32 for allowing the waveguide 36 to receive input signals. An output face plate 40 is connected to the output port 34 for allowing the waveguide 36 to provide output signals, preferably where the power is optimized (e.g., at a self-imaging point). Also, the 1×1 MMI device 30 includes a first side boundary 42 (or wall) and a second side boundary 44 (or wall). The second side boundary 44 is positioned opposite from the first side boundary 42 and may be parallel with the first side boundary 42.

A third boundary (not shown) may be configured as a top planar boundary (or wall) and a fourth boundary (not shown) may be configured as a bottom planar boundary (or wall). The 1×1 MMI device 30 may be arranged flat on an optical integrated circuit substrate with the bottom planar boundary resting on the substrate. Also, the first and second side boundaries 42, 44 and top and bottom planar boundaries are arranged as part of a rectangular prism, whereby the four boundaries have a rectangular cross-section along a propagation path. The four boundaries confine the optical beams traversing through the waveguide 36. The top and bottom planar boundaries may be configured to cause the light beams to spread out in a lateral direction towards the first and second side boundaries 42, 44. The optical beams are configured to reflect off of the side walls (e.g., first and second side boundaries 42, 44) thereby changing the paths of the beams and causing various interference patterns.

FIG. 3 is a diagram illustrating an example of an interference propagation pattern 50, such as a pattern that may result during a simulation or during real-world practice. The interference propagation pattern 50 represents the interference patterns of the 1×1 MMI device 30 of FIG. 2, whereby the interference propagation pattern 50 is shown in an elongated manner with respect to FIG. 2 to show various characteristics of the interference along both an x-axis (i.e., represented by a propagation axis 52) and a y-axis (i.e., directed between the first and second side boundaries 42, 44). A z-axis (not shown) (coming out of the page) may be relatively small (e.g., having the size of a single-mode waveguide) and would not introduce additional reflection characteristics. Brighter portions of the interference propagation pattern 50 show where there is a higher concentration of constructive interference of the light beams. During a design or simulation phase, the dimensions of the waveguide 36 may be determined by heuristic approximations, trial-and-error repetitions, user observations and feedback, Machine Learning (ML) techniques, Reinforcement Learning (RL), and/or calculated in any suitable manner in order to optimize output power at one or more points (i.e., self-imaging points) along the propagation axis 52. For instance, at a midpoint 54 along the propagation axis 52, it can be seen that two self-imaging points are created.

An MMI mixer, for example, is a large uniform waveguide supporting a large number of modes. An optical signal injected at the input of the mixer excites the many modes that propagate at different phase velocities. After some distance, the many modes go back in phase and constructively interfere to reproduce the input optical signal (although mirroring on the lateral axis). This is referred to as the “self-imaging” property of the MMI mixer illustrated in FIG. 3.

### Embodiment of a 1×4 MMI Device

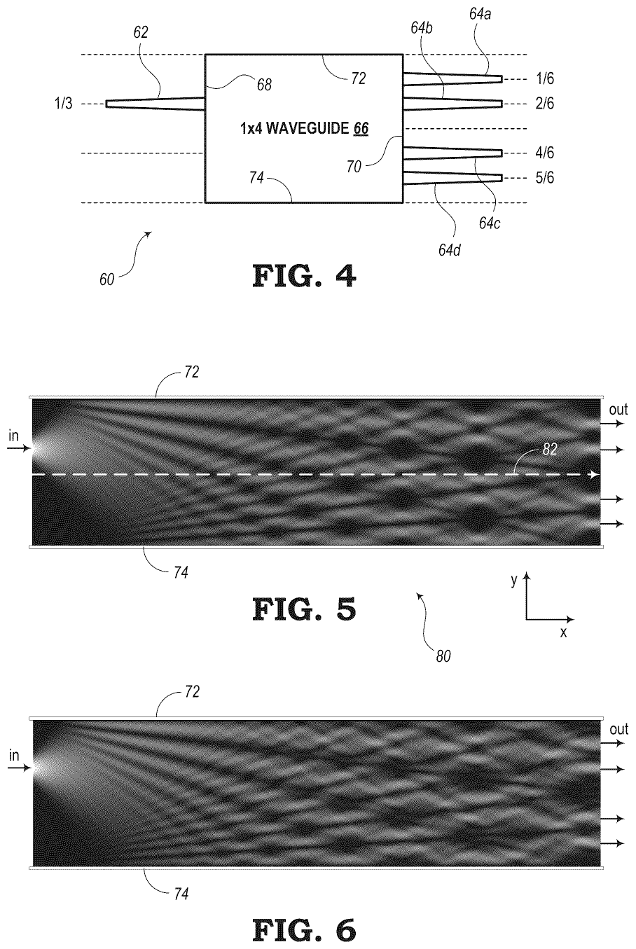

FIG. 4 is a diagram illustrating an embodiment of a 1×4 MMI device 60 (e.g., optical mixer, multi-mode interference coupler, etc.) shown in a compressed form. The 1×4 MMI device 60 includes an input port 62 (e.g., having a tapered configuration) at a 1/3 position and four output ports 64a, 64b, 64c, 64d (e.g., tapered) at 1/6, 2/6, 4/6, 5/6 positions, respectively. The 1×4 MMI device 60 may include a waveguide 66 with a rectangular profile. An input face plate 68 is connected to the input port 62 for allowing the waveguide 66 to receive input signals. An output face plate 70 is connected to the output ports 64a, 64b, 64c, 64d for allowing the waveguide 66 to provide output signals, preferably where the power is substantially equally distributed to each of the output ports 64a, 64b, 64c, 64d. Also, the 1×4 MMI device 60 includes a first side boundary 72 (or wall) and a second side boundary 74 (or wall). The first and second side boundaries 72, 74 may be located on opposite sides of the waveguide 66 and may be parallel with each other. The first and second side boundaries 72, 74 in addition to top and bottom planar boundaries (not shown but would extend out and into the page, along the propagation axis) are configured to confine optical beams traversing through the waveguide 66 by reflection off of the first side boundary 72 (i.e., “left” side) and the second side boundary 74 (i.e., “right” side). The top and bottom walls (not shown but would extend out and into the page, along the propagation axis) may be configured to cause light beams to spread out in a lateral direction towards the first and second side boundaries 72, 74.

FIGS. 5 and 6 are diagrams illustrating examples of interference propagation patterns through the multi-mode waveguide 66 shown in FIG. 4. At a fraction of the self-imaging length, multiple self-images are obtained. For example, at 1/4 of the self-imaging length, a beam splitter can divide a beam by 4, which can be obtained at the output. However, this perfect self-imaging property occurs only in the so-called “paraxial regime” when the device length is large compared to the device width. However, it may be noted that this phenomenon does not typically occur in practical applications.

In the context of an optical device, the “paraxial regime” refers to an approximation where light rays make small angles with the optical axis, allowing for the simplification of mathematical equations. This approximation assumes that angles are small enough to be approximated by their sine or tangent values, making the analysis of optical systems easier. The paraxial regime is particularly useful for analyzing rays that are close to the optical axis (paraxial rays), which is common in lens design, Gaussian optics, and ray tracing. For an MMI (Multimode Interference) device, the paraxial regime helps simplify the analysis of light propagation by focusing on small-angle deviations, which are more manageable within the confines of the device, leading to more accurate and efficient design and performance predictions.

The paraxial regime is considered an approximation because it simplifies the behavior of light rays by assuming that they make small angles with the optical axis. In reality, not all light rays in an optical system travel at such small angles, especially in complex or wide-angle systems. As the angles increase, the assumptions that the sine, tangent, and angle itself are nearly equal break down, leading to inaccuracies. This approximation neglects higher-order effects like aberrations and distortions that occur at larger angles, making it less accurate for off-axis rays or systems where rays deviate significantly from the optical axis. Therefore, while the paraxial regime is useful for simplifying calculations, it does not capture the full complexity of real-world optical behavior and is only accurate within its limited scope.

FIG. 5 shows an example of a top view of an interference propagation pattern 80, such as one which may result during a simulation. The interference propagation pattern 80 produces a splitting over four images under a paraxial approximation, which in theory guarantees a perfect paraxial regime. The interference propagation pattern 80 represents the interference patterns of the 1×4 MMI device 60 of FIG. 4, whereby the interference propagation pattern 80 is shown in an elongated manner with respect to FIG. 4 to show various characteristics of the interference along both an x-axis (i.e., represented by a propagation axis 82) and a y-axis (i.e., directed between the first and second side boundaries 72, 74). A z-axis (not shown) typically does not introduce additional reflection characteristics and typically does not factor into simulation processes. Again, brighter portions of the interference propagation pattern 80 show where there is a higher concentration of constructive interference of the light beams. During a design or simulation phase, the dimensions of the waveguide 66 may be determined by heuristic approximations, trial-and-error repetitions, user observations and feedback, Machine Learning (ML) techniques, Reinforcement Learning (RL), and/or calculated in any suitable manner in order to optimize output power at one or more points (i.e., self-imaging points) along the propagation axis 82.

FIG. 6 instead shows a real calculation (e.g., no paraxial approximation). It may be seen that the low-loss splitting by four is not as good in reality as under the paraxial approximation. However, to mitigate this, the input signal is typically made as large as possible in order to limit the light divergence and operate closer to the paraxial regime. An example of the increase in input signal can be seen, for example, by comparing the size of typical input ports (e.g., FIG. 8) with larger input ports (e.g., FIG. 9).

### Embodiment of a 2×4 MMI Device

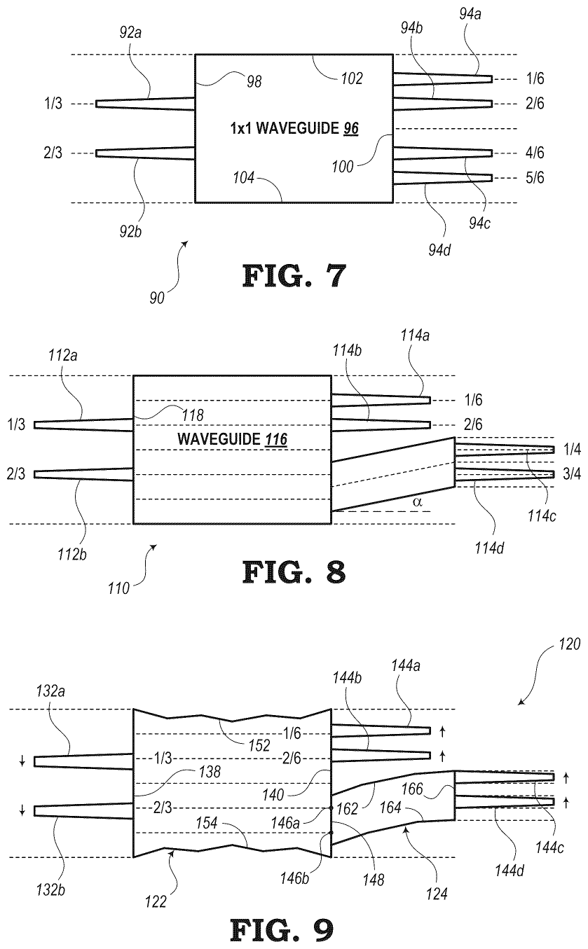

FIG. 7 is a diagram illustrating an embodiment of a 2×4 MMI device 90 (e.g., optical mixer, multi-mode interference coupler, etc.). The 2×4 MMI device 90 includes two input ports 92a, 92b (e.g., each having a tapered configuration) at 1/3 and 2/3 positions, respectively, and four output ports 94a, 94b, 94c, 94d (e.g., tapered) at 1/6, 2/6, 4/6, 5/6 positions, respectively. The 2×4 MMI device 90 may include a waveguide 96 with a rectangular profile. An input face plate 98 is connected to the input ports 92a, 92b for allowing the waveguide 96 to receive input signals. An output face plate 100 is connected to the output ports 94a, 94b, 94c, 94d for allowing the waveguide 96 to provide output signals, preferably where the power is substantially equally distributed to each of the output ports 94a, 94b, 94c, 94d. Also, the 2×4 MMI device 90 includes a first side boundary 102 (or wall) and a second side boundary 104 (or wall). The first and second side boundaries 102, 104 in addition to top and bottom planar walls (not shown) are configured to confine optical beams traversing through the waveguide 96 by reflection off of the first side boundary 102 (i.e., “left” side) and the second side boundary 104 (i.e., “right” side).

The 2×4 MMI device 90 may be configured as a 1×4 splitter but cannot be configured as an optical hybrid device at a core of a coherent receiver used in optical communication systems.

MMI Device with two Multi-Mode Waveguides

FIG. 8 is a diagram illustrating an embodiment of a MMI optical component 110. The MMI optical component 110 of FIG. 8 may represent the MMI optical component 10 of FIG. 1 and/or the 2×4 pair-interference MMI device described in U.S. Pat. No. 9,869,817, the contents of which are incorporated by reference herein.

The MMI optical component 110 may be configured to mix a modulated optical signal (e.g., at input port 112a) with a continuous-wave optical reference signal (e.g., at input port 112b). The two signals going into the input ports 112a, 112b may be provided through the input face plate 118 into the waveguide 116. Each of the input signals is split substantially evenly at the four outputs of the device. Thus, the optical signal at each of the output ports 114a, 114b, 114c, 114d may be a mix of the two signals provided at the two input ports 112a, 112b. Furthermore, the input signals may be mixed with different phase relationships at the four outputs. Specifically, according to various embodiments, the mixed signals may be in quadrature, which can be expressed mathematically by:

$${M}_{i} = {E}_{S} + {E}_{R} \cdot {e}^{j {φ}_{i}}$$

where Mᵢ is the mixed signal at outputs i, E_{S} is the modulated optical signal (e.g., entered at the input port 112a), E_{R} is the optical reference signal (e.g., entered at the input port 112b), and where the input signals E_{S} and E_{R} are mixed with phase offsets ji defined by the following:

$${φ}_{2} = {φ}_{1} + 90 ° ,$$

$${φ}_{3} = {φ}_{2} + 90 ° = {φ}_{1} + 180 ° ,$$

$${φ}_{4} = {φ}_{3} + 90 ° = {φ}_{1} + 270 ° .$$

Ideally, the angular error with respect to the phase offsets should be as small as possible. Also, in some embodiments, each input of the optical hybrid device should be split evenly among the four outputs. Finally, the optical hybrid device should be low-loss, whereby the loss of the total optical power between inputs and outputs should be as small as possible. Summarizing these ideal conditions, performance metrics of an optical hybrid should strive to include a) even splitting, b) mixing in quadrature (e.g., proper phase relationships), and c) low-loss. In practice, the embodiments of the present disclosure are able to improve upon conventional optical devices and approach the ideal characteristics and performance metrics described herein.

Furthermore, U.S. Pat. No. 9,869,817 illustrates an example of a Mach-Zehnder type interferometer, including a 1×2 MMI device and a 2×2 MMI device (in FIG. 3 of this patent). The 1×2 MMI device and 2×2 MMI device are directly connected, without the use of any arms in between. A propagation axis of the 2×2 MMI device is tilted with respect to a propagation axis of the 1×2 MMI device by an angle α (e.g., referred as “type-I tilting”). An incoming light enters the 1×2 MMI device from an input port, propagates along the first propagation axis, and is split into two light beams at self-imaging points at the output of the 1×2 MMI device. These self-imaging points also correspond to input ports to the 2×2 MMI device, whereby the light at these two points propagate along the second propagation axis, splitting and recombining at the two self-imaging output points.

Thus, U.S. Pat. No. 9,869,817 discloses the concatenation of two multi-mode interference mixers or waveguides to achieve the optical hybrid functionality. The 2×4 pair-interference MMI device of U.S. Pat. No. 9,869,817 includes a first 2×4 MMI mixer (or waveguide) followed by a second tilted 2×2 MMI mixer (or waveguide) concatenated directly at two of the four outputs of the 2×4 MMI mixer. This conventional MMI device meets a series of traditionally accepted requirements according to MMI theory, such as:
1) The 2×4 MMI has a uniform width (perfect rectangle);
2) The 2×2 MMI has a uniform width (perfect parallelogram);
3) The input and output ports are identical tapers (same size);
4) The input ports are located at 1/3 and 2/3 of the 2×4 MMI front face;
5) The top output ports are located at 1/6 and 2/6 of the 2×4 MMI end face; and
6) The bottom output ports are located at 1/4 and 3/4 of the 2×2 tilted MMI end face.

Although the conventional implementations work quite well, it should be noted that the embodiments of the present disclosure can improve upon these conventional devices. In some respects, it may be noted that the embodiments of the present disclosure are built on top of the implementations of U.S. Pat. No. 9,869,817. Furthermore, it may be noted that a MMI mixer design that is made as per the traditional MMI theory does not necessarily provide the best performance, because the paraxial regime does not take place in practice. This observation opens the door to a justification for deviating from conventional theory for a MMI mixer (i.e., a uniform large waveguide) and working toward improved optical equipment, as described in the various embodiments described in the present disclosure, device, to a MMI mixer having a “modified,” “contorted,” or “perturbed” shape that does not follow the typical rectangular prism or parallelepiped structure. As such, FIG. 9 describes such a device that breaks with convention, specifically introducing deviations in geometric features to improve some performance metric.

Note, these two mixers are monolithically integrated with one another, i.e., formed together, as opposed to combining two separate mixers. The monolithic integration solves two issues seen in an approach where there is a combination, such as two 1×2 splitters and two 2×2 combiners. This combination approach is very sensitive to high order modes, the presence of a small amount of TE1 mode at the optical hybrid input causes strong wiggles in the hybrid angle spectrum. The second issue is that the phase in the waveguides connecting a combination of mixers is extremely critical. The width of these four guides is required to differ by no more than about 1 nm while only 10 nm is guaranteed typically in fabrication. These issues are resolved due to monolithic integration.

MMI Device with Multi-Mode Waveguides having Non-Parallel Boundary Sections

FIG. 9 is a diagram illustrating an embodiment of a 2×4 MMI optical device 120 (e.g., MMI hybrid device, optical mixer, multi-mode interference coupler, etc.). The 2×4 MMI optical device 120 includes a first multi-mode waveguide 122 and a second multi-mode waveguide 124. In particular, the first and second multi-mode waveguides 122, 124 do not have the traditional rectangular or parallelogram profiles as are usually the custom when designing waveguides and MMI devices. Instead, the side walls of the first and second multi-mode waveguides 122, 124 are contorted and are therefore non-parallel with propagation axes of the respective multi-mode waveguides. In particular, the approach described herein recognizes the basic rectangular shape is not necessarily the best one since the paraxial regime is not taking place. Rather, the intent is to deviate from the basic rectangular shape to a slightly more complicated one and the MMI is then optimized for various parameters.

The 2×4 MMI optical device 120 further includes two input ports 132a, 132b (e.g., each having a tapered configuration) at 1/3 and 2/3 positions, respectively, leading to an input face plate 138 of the first multi-mode waveguide 122, thereby allowing the first multi-mode waveguide 122 to receive input optical signals (e.g., a modulated optical signal and a continuous-wave optical reference signal). The outputs of the first multi-mode waveguide 122 are located at 1/6, 2/6, 4/6, and 5/6 positions along an output face plate 140, whereby a couple of outputs are provided to two output ports 144a, 144b at 1/6 and 2/6 positions, respectively, and a couple of outputs are provided at self-imaging points 146a, 146b at an interception of the output face plate 140 of the first multi-mode waveguide 122 (at positions 4/6 and 5/6 thereof) and an input face plate 148 of the second multi-mode waveguide 124. Furthermore, the second multi-mode waveguide 124 includes an output face plate 166 connected to two additional output ports 144c, 144d. Ideally, the optical power (or light intensity) is equally distributed to each of the output ports 144a, 144b, 144c, 144d and/or is equally distributed to each of the output ports 144a, 144b and self-imaging points 146a, 146b. In some embodiments, the input ports 132a, 132b and output ports 144a, 144b, 144c, 144d may each be configured as single-mode optical waveguides.

The first multi-mode waveguide 122 (e.g., 2×4 MMI device) does not have a conventional rectangular shape, but instead has a first side boundary 152 (or wall) and a second side boundary 154 (or wall), each having one or more sections thereof that are non-parallel to a propagation axis of the first multi-mode waveguide 122. The first and second side boundaries 152, 154 are located on opposite sides of the first multi-mode waveguide 122. However, as opposed to other embodiments, the first and second side boundaries 152, 154 are not parallel with each other, but instead have one or more sections that are neither parallel with a propagation axis nor parallel with the other side boundary.

In some embodiments, the first and second side boundaries 152, 154 include deviations in geometric features associated therewith. These deviations may be with respect to an axis parallel to the propagation axis of the MMI 122. One or more portions of the first and second side boundaries 152, 154 may increase the width of the MMI 122 (e.g., the distance between the first and second side boundaries 152, 154) along the length of the MMI 122 by skewing away from the propagation axis, and one or more other portions of the first and second side boundaries 152, 154 may decrease the width of the MMI 122 by skewing towards the propagation axis. In the example shown in FIG. 9, the MMI 122 includes multiple widening sections interleaved with multiple narrowing sections, although other embodiments are contemplated.

In other embodiments, deviations in the first and second side boundaries 152, 154 may curve the MMI 122 along at least a portion of the length of the MMI 122. For example, curves in one or both of the first and second side boundaries 152, 154 may curve the propagation axis of the MMI 122.

The first and second side boundaries 152, 154 in addition to top and bottom boundaries or walls (not shown but would extend out and into the page, along the propagation axis) are configured to confine optical beams traversing through the first multi-mode waveguide 122 by reflection off of the first side boundary 152 (i.e., “left” side) and the second side boundary 154 (i.e., “right” side). The top and bottom walls (not shown) may be configured to cause light beams to spread out in a lateral direction towards the first and second side boundaries 152, 154. It may be noted that the first and second side boundaries 152, 154 are not necessarily drawn to scale and/or are not limited to the specific shape or design as shown, but may include any suitable shape or design to optimize transmission characteristics. Also, FIG. 9 shows an exaggeration of “contorted” or “modified” wall shapes. Nevertheless, it should be noted that one or more sections of each of the first and second side boundaries 152, 154 are non-parallel to the propagation axis and therefore introduce modified reflection characteristics for the first multi-mode waveguide 122. In some embodiments, the first and second side boundaries 152, 154 with the top and bottom planar boundaries may have a rectangular cross-sectional shape at any point along a propagation path of the first multi-mode waveguide 122, despite the irregular shapes of the first and second side boundaries 152, 154. The rectangular cross-sectional shape may change continuously along the propagation path.

Likewise, the second multi-mode waveguide 124 (e.g., 2×2 MMI device) may also be configured in a way that bucks convention. Specifically, the second multi-mode waveguide 124 may also have an unconventional shape as opposed to the traditional parallelepiped shape. That is, the second multi-mode waveguide 124 has a first side boundary 162 (or wall) and a second side boundary 164 (or wall), each having one or more sections thereof that are non-parallel to a propagation axis of the second multi-mode waveguide 124. Similar to the first multi-mode waveguide 122, the first and second side boundaries 162, 164 of the second multi-mode waveguide 124 are located on opposite sides but portions may not be parallel with each other.

In some embodiments, the first and second side boundaries 162, 164 include deviations in geometric features associated therewith. As shown in the example of FIG. 9, these deviations curve the MMI 124 along the propagation axis thereof. At the interface between the output face plate 140 and the input face place 148, the first side boundary 162 makes an acute angle with the output face plate 140 and the second side boundary 164 makes an obtuse angle with the output face plate 140. As such, the propagation axis of the MMI 122 is at a non-zero angle with the propagation axis of the MMI 124 at the input face place 148. The first and second side boundaries 162, 164, and the propagation axis, then curve in a clockwise direction along the MMI 124, such that the angle between the propagation axis of the MMI 122 and the propagation axis of the MMI 124 is reduced from the input face plate 148 to the output face plate 166.

In other embodiments, the in the first and second side boundaries 162, 164 deviations may be with respect to an axis parallel to the propagation axis of the MMI 124. One or more portions of the first and second side boundaries 162, 164 may increase the width of the MMI 124 (e.g., the distance between the first and second side boundaries 162, 164) along the length of the MMI 124 by skewing away from the propagation axis, and one or more other of the first and second side boundaries 162, 164 may decrease the width of the MMI 122 by skewing towards the propagation axis.

The first and second side boundaries 162, 164 in addition to top and bottom boundaries or walls (not shown) are configured to confine optical beams traversing through the second multi-mode waveguide 124 by reflection off of the first side boundary 162 (i.e., “left” side) and the second side boundary 164 (i.e., “right” side). The top and bottom walls may be configured to cause light beams to spread out in a lateral direction towards the first and second side boundaries 162, 164. It may be noted that the first and second side boundaries 162, 164 are not necessarily drawn to scale and/or are not limited to the specific shape or design as shown, but may include any suitable shape or design to optimize transmission characteristics. Again, FIG. 9 shows an exaggeration of “contorted” or “modified” wall shapes. Nevertheless, it should be noted that one or more sections of each of the first and second side boundaries 162, 164 are non-parallel to the propagation axis and therefore introduce modified reflection characteristics for the second multi-mode waveguide 124. In some embodiments, the first and second side boundaries 162, 164 with the top and bottom planar boundaries may have a rectangular cross-sectional shape at any point along a propagation path of the second multi-mode waveguide 124, despite the irregular shapes of the first and second side boundaries 162, 164. Again, the rectangular cross-sectional shape may change continuously along the propagation path.

The first and second side boundaries 162, 164 in addition to top and bottom walls (not shown) are configured to confine optical beams traversing through the second multi-mode waveguide 124 by reflection off of the first side boundary 162 (i.e., “left” side) and the second side boundary 164 (i.e., “right” side). Again, it may be noted that the first and second side boundaries 162, 164 are not necessarily drawn to scale and/or are not limited to the specific shape or design as shown. Also, FIG. 9 shows an exaggeration of “contorted” or “modified” wall shapes for illustration purposes. Nevertheless, it should be noted that one or more sections of each of the first and second side boundaries 162, 164 are non-parallel to the propagation axis and therefore introduce modified reflection characteristics for the second multi-mode waveguide 124. That is, in practice the deviations in geometric features may be small relative to the overall size.

It should be noted that the embodiments of the first and second multi-mode waveguides 122, 124 deviate from the six traditional requirements of MMI theory mentioned above. For example, in addition to breaking convention with respect to uniform side walls, the embodiments described herein also deviate from the concept of input and output ports having identical tapered characteristics. In the embodiment of FIG. 9, it may be noted that the input ports 132a, 132b are slightly larger than the output ports 144a, 144b, 144c, 144d and the input and output ports shown in FIG. 8. Also, it may be noted that the output ports 144a, 144b may be offset along the output face plate 140 of the first multi-mode waveguide 122 in contrast to the 1/6 and 2/6 positioning as shown in FIG. 8, and the output ports 144c, 144d may be offset along the output face plate 166 of the second multi-mode waveguide 124 in contrast to the 1/4 and 3/4 positioning as shown in FIG. 8. Thus, the input ports 132a, 132b and output ports 144a, 144b, 144c, 144d may be offset from a natural spacing arrangement or simple fractional position as described above with respect to other embodiments.

The various deviations (e.g., design tweaking) may be selected or calculated in an iteration process during a simulation stage. In simulations, device performance can be optimized regarding a) even splitting of power, b) mixing in quadrature (e.g., proper phase relationships), and c) low-loss. Thus, the same performance goals can be met by the embodiments of the present disclosure and can surpass the results of conventional structures, while also allowing for modifications from the conventional designs.

### Process for Simulating Geometric Features of a Waveguide

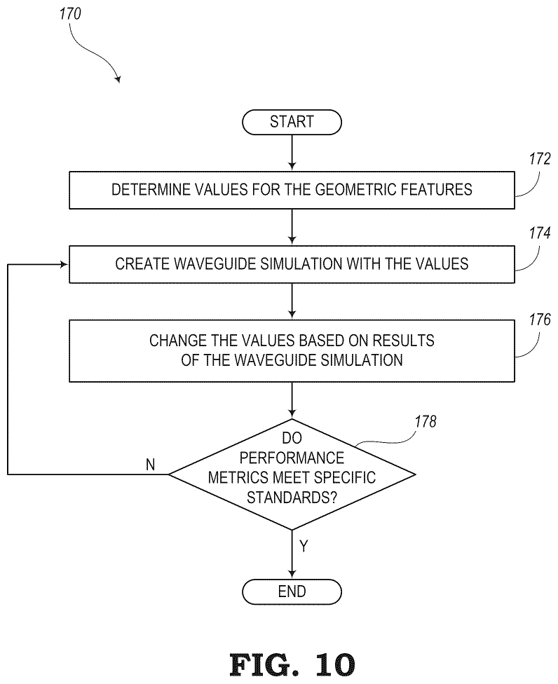

FIG. 10 is a flow diagram illustrating an embodiment of a process 170 for determining geometric features of the 2×4 MMI optical device 120 of FIG. 9. The process 170 includes a step of determining values for the geometric features. For example, the geometric features may include at least a) dimensions and shape of the first side boundary 152 of the first multi-mode waveguide 122, b) dimensions and shape of the second side boundary 154 of the first multi-mode waveguide 122, c) dimensions and shape of the first side boundary 162 of the second multi-mode waveguide 124, d) dimensions and shape of the second side boundary 164 of the second multi-mode waveguide 124, e) sizes of the input ports 132a, 132b and output ports 144a, 144b, 144c, 144d, and/or f) lateral offset of the input ports 132a, 132b and output ports 144a, 144b, 144c, 144d along respective input and output face plates 138, 140, 166.

Furthermore, the process 170 includes a step (block 174) of creating a waveguide simulation with the values determined in block 172. In some embodiments, the waveguide may include multiple waveguides incorporated in a hybrid MMI device (e.g., the 2×4 MMI optical device 120 of FIG. 9). Also, the process 170 includes a step of changing the values based on results of the waveguide simulation, as indicated in block 176. These changes may be made in order to improve the simulation results. Negative changes can be eliminated, while positive changes can be kept, similar to a Reinforcement Learning (RL) procedure. Alternatively, the trial-and-error nature of the process 170 could include, for changing the values in block 176, defining trial values as a deviation from the values, creating a waveguide simulation with the trial values, and replacing the values by the trial values if performance improvement is obtained.

Next, the process 170 includes a step of determining if the performance metrics meet specific standards for MMI designs, as indicated in decision block 178. For example, the performance metrics may include the three goals mentioned above with respect to a) providing even power splitting among output ports, b) providing proper phase relationships between the output signals (e.g., four outputs having quadrature or 90° separation therebetween), and c) signal loss less than a predetermined threshold (e.g., optical signals having less than a 7 dB loss over an entire bandwidth).

An optical hybrid device may also be wavelength dependent. The optical hybrid mixes two input signals as required by coherent detection. It is typically desired that the device operates not only at a specific wavelength, but also over a specific wavelength range (e.g., the C-band having the range of about 1528 nm to about 1568 nm). In the optimization process of an optical hybrid device, the band of operation can be considered. The self-imaging property described herein may occur after a certain propagation distance in the multi-mode waveguide. This distance depends on the wavelength and can therefore be considered when designing and/or simulating an MMI waveguide. In a practical situation, a certain length is chosen so that the device works optimally at a desired wavelength and with sufficient operation within a certain wavelength range (e.g., the C band). The shape deviations can be selected to optimize the performance over the full wavelength range of interest.

In particular, simulation experiments have shown that some geometric features are able to improve performance of hybrid MMI devices. These geometric features again may include at least a) having input ports slightly larger than the output ports, b) adjusting the lateral location of the ports to offset positions, particularly by moving the output ports 144c, 144d from the second multi-mode waveguide 124 towards the output ports 144a, 144b (e.g., towards a left side), c) adjusting the side walls (e.g., the first and second side boundaries 152, 154) to form a butterfly-like shape where the side walls are closer to each other at a central position along the propagation axis than start and end positions along the propagation axis, and/or d) altering the dimensions of the second multi-mode waveguide 124 to not only keep the tilted aspect, but also to form a bent shape.

### Graphs Showing Results of Transmission Improvements

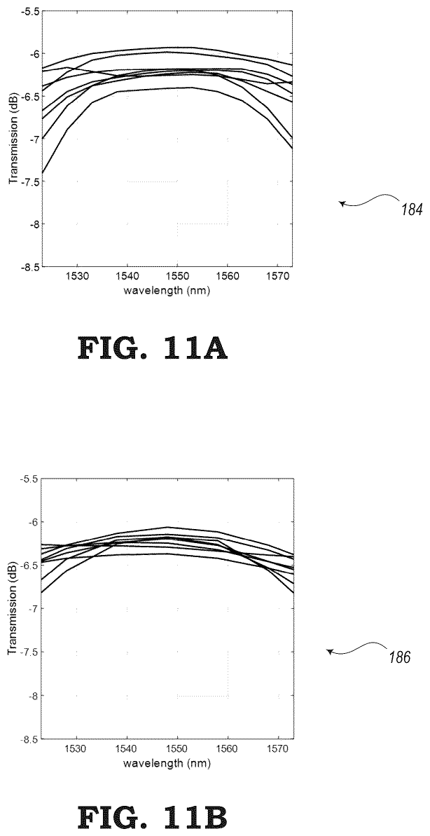

FIGS. 11A and 11B show graphs 184 and 186, respectively. The graphs 184, 186 are configured to emphasize a comparison between the transmission characteristics associated with the MMI hybrid device (e.g., the 2×4 MMI optical device 120 of FIG. 9) versus the transmission characteristics of other MMI devices (e.g., the MMI optical component 110 of FIG. 8 or other MMI hybrid devices). In particular, FIG. 11A shows the results of an MMI device that follows the traditional MMI theory and has no geometric feature deviations, while FIG. 11B shows the results of the 2×4 MMI optical device 120 of FIG. 9 having the specific and intentional geometrical deviations. Each of the graphs 184, 186 shows the transmission power with respect to the eight different input-to-output combinations (i.e., from the two inputs to the four outputs) over the transmission spectrum. It may be noted that a transmission of −6 dB corresponds to 25% of the original transmission power. Thus, when the optical power of one input signal is divided into four outputs, the value of an ideal splitting would be 25% at each of the outputs. It may be noted in FIG. 11B that approximately the same power is presented with each of the eight input-to-output combinations for the optical hybrid device with physical deviations as described herein. It can also be seen that the 2×4 MMI optical device 120 provides a clear improvement in terms of loss and consistency over the spectral range of interest. Improvement in the quadrature phase accuracy can also be obtained in the same manner.

It should be noted that the concept of altering the geometric features of the optical MMI devices and MMI hybrid devices with multiple waveguides described herein can also be applied to other MMI-based devices. For example, the geometric feature simulation and fabrication methods for modifying typical waveguides can also be applied to splitters and combiners, which can also lead to better performances than their conventional uniform-width counterparts.

### Further Considerations

The embodiments of the non-rectangular MMI devices described in the present disclosure provide non-even splitting in configurations referred to as a “butterfly MMI.” In that case, the rectangular shape may be changed to a double-trapezoidal shape. Still using a similar approach, a compact non-uniform MMI may be proposed. The embodiments of the present disclosure may bring the advantage of compacity. Apart from these two works, a random-like non-uniform perturbation on every aspect of a MMI is considered to be novel.

Certain benefits may be gained from the geometric contortion implementations. For example, the embodiments described herein can improve the performance of an optical hybrid device. Existing optical communication products may be redesigned, as described herein, which may yield an improvement at the wafer-level and at the package-level. In future products, the systems and methods described herein can enable an improvement in the specifications and applications that could be of interest to customers. For example, one area that may be improved by using the embodiments described herein include Silicon Photonics (SiPhot) devices, optical integrated chips, coherent receivers, and/or other types of optical/photonic components used in communication networks.

Simulation techniques, for example, may include entering a description of various geometric characteristics or parameters with a certain number of points that may deviate from conventional geometries. These points may be selected randomly or can be derived using Machine Learning (ML) techniques and/or Reinforcement Learning (RL). Then, a simulation can be run with the selected points. A user (e.g., circuit designer) may look at the performance (and/or a ML method may analyze the performance according to certain criteria). Based on the observations and results, it can be determined whether or not the performance metrics are improved according to predefined goals. Additional deviations can be made from the last proposed set of geometric parameters to attempt to improve the performance results. This can be a back and forth procedure using any number of iterations as needed to obtain an improved or optimized configuration. The goal of various optimization strategies may include improving one or more of the following three factors to any certain degree: a) splitting the power evenly among the outputs, b) providing outputs with certain phase relationships (e.g., quadrature phase shifting), c) loss characteristics. For example, if loss is a more significant concern (for the enterprise) than the other two factors, than the results showing better signal power characteristics may be considered to be a higher priority than equal power distribution to the outputs and/or phase characteristics between different outputs.

### CONCLUSION

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated.

What is claimed is:

1. A multi-mode waveguide having a propagation axis extending therethrough, the multi-mode waveguide comprising:
a top planar boundary parallel to the propagation axis;
a bottom planar boundary parallel to the propagation axis; and
a first side boundary having at least one section that is non-parallel to the propagation axis with deviations in geometric features associated therewith.

2. The multi-mode waveguide of claim 1, further comprising a second side boundary opposite of the first side boundary, the second side boundary having at least one section that is non-parallel to the propagation axis with deviations in geometric features associated therewith.

3. The multi-mode waveguide of claim 2, wherein the first and second side boundaries each include multiple sections that are non-parallel to the propagation axis with deviations in geometric features associated therewith.

4. The multi-mode waveguide of claim 3, wherein an arrangement of the multiple sections of the first and second side boundaries results in the top planar boundary and bottom planar boundary essentially forming a butterfly-like shape.

5. The multi-mode waveguide of claim 3, wherein the multi-mode waveguide includes a rectangular cross-section that varies along its length.

6. The multi-mode waveguide of claim 1, wherein the multi-mode waveguide is a first multi-mode waveguide connected directly to a second multi-mode waveguide to form a device having the functionality of an optical hybrid mixer.

7. The multi-mode waveguide of claim 6, further comprising multiple input ports at an input face plate of the first multi-mode waveguide, a first set of output ports at an output face plate of the first multi-mode waveguide, and a second set of output ports at an output face plate of the second multi-mode waveguide.

8. The multi-mode waveguide of claim 7, wherein each of the multiple input ports is larger than each of the first and second sets of output ports.

9. The multi-mode waveguide of claim 7, wherein the multiple input ports are offset from a natural spacing arrangement along the input face plate of the first multi-mode waveguide, and wherein the first and second sets of output ports are offset from a natural spacing arrangement along the output face plates of the first and second multi-mode waveguides.

10. The multi-mode waveguide of claim 6, wherein the first multi-mode waveguide is a 2×4 waveguide having two inputs and four outputs, wherein the second multi-mode waveguide is a 2×2 waveguide having two inputs and two outputs, and wherein two of the four outputs of the 2×4 waveguide are configured to propagate optical signals directly to the two inputs of the 2×2 waveguide.

11. The multi-mode waveguide of claim 6, wherein the second multi-mode waveguide includes a second top planar boundary and a second bottom planar boundary parallel to a second propagation axis of the second multi-mode waveguide and further includes one or more side boundaries each having at least one section that is non-parallel to the second propagation axis.

12. The multi-mode waveguide of claim 11, wherein the second propagation axis of the second multi-mode waveguide is angled with respect to the propagation axis of the first multi-mode waveguide.

13. The multi-mode waveguide of claim 1, wherein the geometric features of the first side boundary are configured to improve transmission characteristics with respect to one or more of a) splitting optical signals substantially evenly to a plurality of output ports, b) providing desired equal phase offsets of the optical signals at the plurality of output ports when the multi-mode waveguide in used in an optical hybrid, and c) providing relatively low loss.

14. The multi-mode waveguide of claim 1, further comprising one or more single-mode input ports and one or more single-mode output ports with deviations in geometric features associated therewith.

15. The multi-mode waveguide of claim 1, wherein the multi-mode waveguide has a non-rectangular, non-parallelogram, and non-trapezoidal profile.

16. The multi-mode waveguide of claim 1, wherein the multi-mode waveguide is relatively flat and is fabricated on an optical integrated circuit board.

17. The multi-mode waveguide of claim 1, wherein the top planar boundary is parallel with the bottom planar boundary.

18. The multi-mode waveguide of claim 1, wherein the geometric features of the first side boundary are determined based on
determining values for the geometric features,
creating a waveguide simulation with the values,
changing the values based on results of the waveguide simulation, and
repeating the creating and changing steps until the waveguide simulation meets a set of performance metrics.

19. A method for simulating geometric features of a side boundary of a waveguide, the process comprising steps of:
determining values for the geometric features,
creating a waveguide simulation with the values,
changing the values based on results of the waveguide simulation, and
repeating the creating and changing steps until the waveguide simulation meets a set of performance metrics.

20. An optical mixer comprising:
a first multi-mode waveguide and a second multi-mode waveguide;
a plurality of input ports connected to the first multi-mode waveguide; and
a plurality of output ports each connected to one of the first multi-mode waveguide and the second multi-mode waveguide,
wherein one or more geometric features of any of the first multi-mode waveguide, the second multi-mode waveguide, the plurality of input ports, and the plurality of output ports include deviations selected based on one or more performance metrics.
